(19) United States
(12) Patent Application Publication
(10) Pub. No.: US 2015/0183463 A1
(43) Pub. Date: Jul. 2, 2015

(54) PUSHCART

(71) Applicant: Murata Manufacturing Co., Ltd., Kyoto (JP)

(72) Inventors: Kenichi Shirato, Kyoto (JP); Shigeru Tsuji, Kyoto (JP)

(21) Appl. No.: 14/658,566

(22) Filed: Mar. 16, 2015

Related U.S. Application Data
(63) Continuation of application No. PCT/JP2013/073609, filed on Sep. 3, 2013.

(30) Foreign Application Priority Data
Sep. 18, 2012 (JP) 2012-204014

(51) Int. Cl. B62D 11/00; A61H 3/04; B62K 3/00; B62D 11/02

(52) U.S. Cl. CPC B62D 11/003; B62D 11/02; A61H 3/04; B62K 3/007; A61H 2003/043

(57) ABSTRACT

Provided is a pushcart that can automatically change a yaw rotation range. A first main wheel (11A) and a second main wheel (11B) are respectively driven and controlled so that a change of angle in a yaw direction falls within a range of given target values (a first target value and a second target value). In the case where a yaw angular velocity ω is determined to be in a range from −α to α, a control unit (21) controls the first main wheel (11A) and the second main wheel (11B) so that the yaw angular velocity ω becomes 0, and corrects the yaw angular velocity to 0 (or a value near 0). Accordingly, the yaw angular velocity ω falls within the range from the first target value to the second target value (−α to α).

### BACKGROUND OF THE INVENTION

1. Field of the Invention

This invention relates to pushcarts that have wheels, and particularly relates to pushcarts that drive and control wheels.

2. Description of the Related Art

Thus far, there have been pushcarts having wheels capable of yaw axis rotation, such as that described in Patent Document 1.

In the pushcart according to Patent Document 1, manipulating a lever provided near a user's feet makes it possible to switch between three states, namely a state in which yaw axis rotation is prohibited, a state in which rotation is permitted within a limited rotation range, and a state in which completely free rotation is permitted.

Through this, it is possible to keep the pushcart advancing in a straight line, change the direction of the pushcart within a given range, change the direction of the pushcart greatly, and so on.

Patent Document 1: Japanese Unexamined Patent Application Publication No. 2011-168236

### BRIEF SUMMARY OF THE INVENTION

In the case where yaw axis rotation is set to be completely free, there is a risk of falls if the user sways while advancing. Furthermore, with the pushcart according to Patent Document 1, it is necessary to manually manipulate the lever in the case where the yaw rotation range is to be restricted.

Accordingly, it is an object of this invention to provide a pushcart capable of automatically restricting a yaw rotation range.

A pushcart according to the present invention includes a pair of wheels, a main body portion that supports the pair of wheels so as to be rotatable in a pitch direction, a driving control unit that drives and controls each wheel in the pair of wheels individually, and a yaw detection means that detects a change of angle of the main body portion in a yaw direction. The change of angle in the yaw direction refers to a yaw angle changing, and detecting the change of angle in the yaw direction refers to detecting the yaw angle or a yaw angular velocity, for example.

Here, the driving control unit drives and controls each wheel in the pair of wheels individually so that the change of angle in the yaw direction falls within a range from a first target value to a second target value.

In this manner, by controlling the driving of each wheel in the pair of wheels individually so that the change of angle in the yaw direction falls within a predetermined range, a range of yaw rotation can be restricted automatically, which makes it possible to prevent a user from swaying and falling. Note that the change of angle in the yaw direction may be detected by, for example, using a magnetic sensor and detecting an angle of the current front direction of the pushcart relative to a reference direction (for example, the front direction of the pushcart when in a stopped state), or the yaw angular velocity may be detected using a gyrosensor. In addition, the change of angle in the yaw direction (the yaw angle or the yaw angular velocity) can also be detected by using a rotary encoder to detect the rotation angles of each of the wheels in the pair of wheels and using angular velocities calculated based on the respective detected rotation angles.

Meanwhile, it is preferable that in the case where the change of angle in the yaw direction is within a first predetermined value range for a predetermined amount of time, the driving control unit set the first target value and the second target value to fall within the first predetermined value range. In other words, in the case where the change of angle in the yaw direction falls within a given range (a first predetermined value) continuously for a certain amount of time, the driving control unit determines that the user is advancing straight, and holds the change of angle in the yaw direction near 0 (for example, so that the yaw angular velocity is within 0±α (rad/s)). In the case where the change of angle in the yaw direction is greater than or equal to the first predetermined value temporarily, it is determined that the user is changing a direction intentionally, and control for suppressing the change of angle in the yaw direction is not carried out. This makes it possible to prevent falls caused by small sways.

Meanwhile, it is preferable that in the case where the change of angle in the yaw direction is outside a second predetermined value range for a predetermined amount of time, the driving control unit set the first target value and the second target value to fall within the second predetermined value range. In other words, in the case where the change of angle in the yaw direction has become greater than or equal to a given range (a second predetermined value) continuously for a certain amount of time, the driving control unit determines that the user is swaying greatly, and brings the change of angle in the yaw direction to within the range (for example, so that the yaw angular velocity is no greater than β or no less than −β). This makes it possible to prevent falls caused by large sways.

Meanwhile, the pushcart according to the present invention may include a roll detection means that detects a change in angle of the main body portion in a roll direction. In this case, in the case where the change of angle in the roll direction is outside a third predetermined value range for a predetermined amount of time, the driving control unit changes the first target value and the second target value. For example, in the case where the yaw angular velocity is made no greater than β or no less than −β, and the change of angle in the roll direction has become greater than or equal to a third predetermined value for a predetermined amount of time, the first target value or the second target value is offset so that the yaw angular velocity is no greater than β−σ or no less than −β+α. Note that σ may be changed in accordance with a change of angle in the roll direction. Furthermore, this configuration may be combined with a configuration that holds the yaw angular velocity within 0±α (rad/s) in the case where the change of angle in the yaw direction is within the aforementioned first predetermined value. Through this, in the case where, for example, there is a slope in the left-right direction relative to the direction of advancement, the user can be permitted to change directions intentionally while preventing the pushcart from moving unintentionally in the downward direction of the slope.

Note that the pushcart according to the present invention may include a target value input means that accepts an input of the first target value or the second target value. A configuration that accepts an input of the first predetermined value range, the second predetermined value range, or the third predetermined value range is also possible.

### Advantageous Effects of Invention

According to this invention, a yaw rotation range can be restricted automatically.

### BRIEF DESCRIPTION OF THE SEVERAL VIEWS OF THE DRAWINGS

FIG. 1 is a perspective view illustrating a pushcart.

FIG. 2 is a block diagram illustrating the configuration of a pushcart.

FIGS. 3A-3C includes diagrams illustrating an example (a first example) of correcting a yaw angular velocity to 0.

FIG. 4 is a diagram illustrating an example of calculating a yaw angular velocity.

FIGS. 5A-5C includes diagrams illustrating an example (a second example) of suppressing a yaw angular velocity to within a predetermined value.

FIGS. 6A-6C includes diagrams illustrating a combination of the first example and the second example.

FIGS. 7A-7C includes diagrams illustrating a variation on the second example.

FIGS. 8A-8C includes diagrams illustrating an example (a third example) of correcting a yaw angular velocity to 0 in accordance with a roll angle.

FIGS. 9A-9F includes diagrams illustrating an example (a variation on the third example) of offsetting a reference yaw angular velocity in accordance with a roll angle.

FIGS. 10A-10D includes diagrams illustrating a combination of the first example and the variation on the third example.

### DETAILED DESCRIPTION OF THE INVENTION

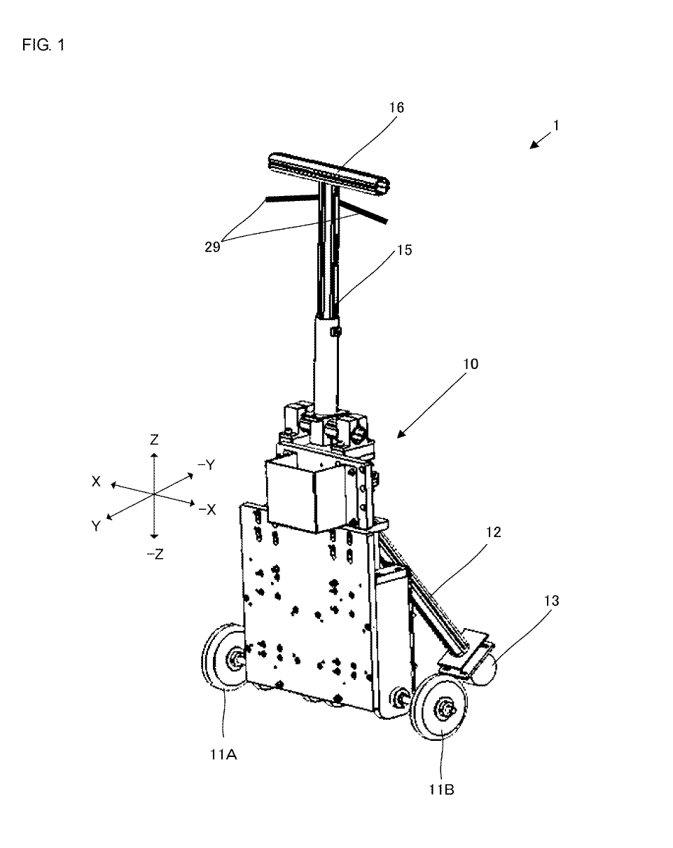

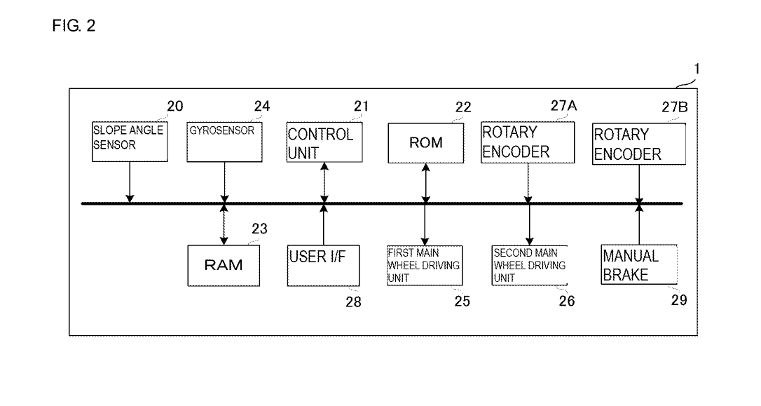

FIG. 1 is a perspective view illustrating a pushcart 1 embodying a moving object according to the present invention. FIG. 2 is a block diagram illustrating the configuration of the pushcart 1.

The pushcart 1 includes, for example, a parallelepiped main body portion 10. The main body portion 10 has a shape that is longer in a vertical direction (a Z, −Z direction in the drawings) and shorter in a depth direction (a Y, −Y direction in the drawings). The main body portion 10 includes a board for control, a battery, and the like in its interior.

A first main wheel 11A is attached to an end portion on a right side (the X direction in the drawings) of a lower portion of the main body portion 10 in a lower-vertical direction (the −Z direction), and a second main wheel 11B is attached to an end portion on a left side (the −X direction in the drawings) of the lower portion of the main body portion 10 in the lower-vertical direction. This first main wheel 11A and the second main wheel 11B are driven and controlled individually. By driving and controlling a rotational velocity of the first main wheel 11A and the second main wheel 11B individually, the pushcart 1 can control rotation in a yaw direction (rotation central to the Z-axis in the drawings).

One end of a handle 15 that is cylindrical in shape, for example, is attached to an upper portion of the main body portion 10 in the vertical direction, and a T-shaped grip portion 16 is attached to another end of the handle 15. A user interface (a user I/F 28 illustrated in FIG. 2) including a power switch and the like is provided in the grip portion 16. A manual brake 29 is provided in a position of the handle 15 that is close to the grip portion 16 (the manual brake is not a necessary element in the present invention). By gripping the grip portion 16 or resting his/her forearms or the like on the grip portion 16, a user can push the pushcart 1 using friction between the grip portion and the forearms or the like.

Note that a cover is actually attached to the main body portion 10 so that the internal board and the like cannot be seen from the exterior.

One end of a bar-shaped support portion 12 is attached to a rear surface (the −Y direction) of the main body portion 10. One end of the support portion 12 is connected to the main body portion 10 in a rotatable manner. An assist wheel 13 is attached to another end of the support portion 12. The support portion 12 supports the main body portion 10 and prevents the main body portion 10 from falling. Although the support portion 12 and the assist wheel 13 are not necessary elements in the present invention, providing the assist wheel 13 results in the first main wheel 11A, the second main wheel 11B, and the assist wheel 13 making contact with the ground even in the case where the main body portion 10 is greatly tilted from the vertical direction when the power is turned off, and makes it possible to push the pushcart. Furthermore, two or more support portions 12 and assist wheels 13 may be provided.

Next, a configuration and basic operations of the pushcart 1 will be described. As illustrated in FIG. 2, the pushcart 1 includes an angle of slope sensor 20, a control unit 21, a ROM 22, a RAM 23, a gyrosensor 24, a first main wheel driving unit 25, a second main wheel driving unit 26, a rotary encoder 27A, a rotary encoder 27B, the user I/F 28, and the manual brake 29.

The control unit 21 is a functional unit that performs overall control of the pushcart 1, and realizes various operations by reading out programs stored in the ROM 22 and loading those programs in the RAM 23. The angle of slope sensor 20 detects an angle of slope of a pitch direction of the main body portion 10 (a rotation direction that is central to an axis of the first main wheel 11A and the second main wheel 11B in FIG. 1) relative to the vertical direction, and outputs the angle of slope to the control unit 21. The gyrosensor 24 detects an angular velocity of the main body portion 10 in the pitch direction, and outputs the angular velocity to the control unit 21. Note that the pushcart 1 may include an accelerometer that detects acceleration of the main body portion 10 in respective directions, a rotary encoder that detects an angle of intersection between the main body portion 10 and the support portion 12, or the like.

The rotary encoder 27A and the rotary encoder 27B respectively detect rotation angles of the first main wheel 11A and the second main wheel 11B, and output detection results to the control unit 21.

As a basic operation, the control unit 21 detects a change in the angle of slope of the main body portion 10 in the pitch direction based on detection results from the gyrosensor 24 and the angle of slope sensor 20, and controls the first main wheel driving unit 25 and the second main wheel driving unit 26 so that a change in the angle of the main body portion 10 in the pitch direction becomes 0 and the angle of the main body portion 10 relative to the vertical direction becomes 0 (or a value near 0). The first main wheel driving unit 25 and the second main wheel driving unit 26 are functional units that drive motors for shafts to which the first main wheel 11A and the second main wheel 11B are attached, and rotate the first main wheel 11A and the second main wheel 11B, respectively, under the control of the control unit 21. Although an example in which the gyrosensor 24 and the angle of slope sensor 20 are used as a means for detecting a change in the angle of slope of the main body portion 10 in the pitch direction, it should be noted that an accelerometer can be used, and any other type of sensor may be used as well. For example, in the case where the angle at which the support portion 12 intersects with the main body portion 10 is detected using a rotary encoder, the angle of slope of the main body portion 10 relative to the vertical direction can also be estimated from that angle of intersection.

In this manner, the pushcart 1 carries out inverted pendulum control as a basic operation, and controls the attitude of the main body portion 10 so as to keep that attitude constant. The pushcart 1 maintains the constant attitude even in the case where the user grips the grip portion 16 and pushes the pushcart 1. By performing inverted pendulum control, a length in the depth direction can be greatly reduced, which makes it possible to reduce a turning radius when turning in a yaw angle direction; an improvement in small-radius turning capabilities can be expected as a result. On the other hand, compared to a non-inverted control pushcart that has three or more wheels and thus has static stability, applying inverted pendulum control reduces the moment of inertia central to the yaw axis of the pushcart, which makes it possible for the user to turn the pushcart with a small amount of force. This may result in unintended turning operations for users with weak lower bodies. From the standpoint of correcting this deficiency, the present invention has a great effect in pushcarts in which inverted pendulum control is applied. However, inverted pendulum control is not necessary in the present invention, and the pushcart 1 can be used even simply when the first main wheel 11A, the second main wheel 11B, and the assist wheel 13 are brought into contact with the ground.

Furthermore, the pushcart 1 according to the present embodiment can prevent the user from swaying in the yaw direction and prevent falls by driving and controlling the first main wheel 11A and the second main wheel 11B, respectively, so that a change of angle in the yaw direction falls between given target values (a first target value and a second target value).

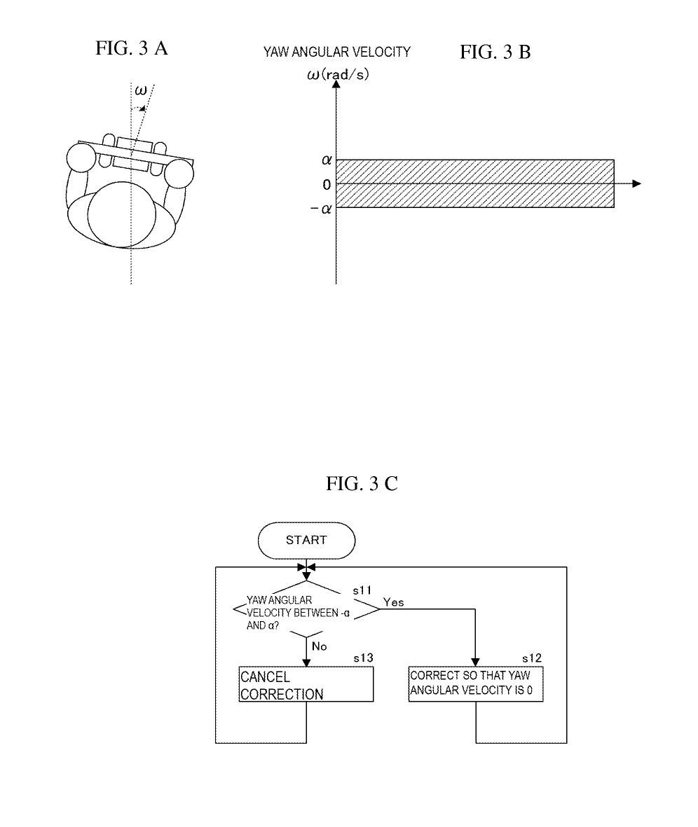

First, a first example will be described. FIG. 3 includes diagrams illustrating an example of correcting the yaw angular velocity to 0 (or a value close to 0) as the first example. In this case, the first target value and the second target value are 0 (that is, the first target value and the second target value match). FIG. 3A is a diagram illustrating a yaw angular velocity ω, FIG. 3B is a diagram illustrating a relationship between the yaw angular velocity ω and control being on or off, and FIG. 3C is a flowchart illustrating operations performed by the control unit 21.

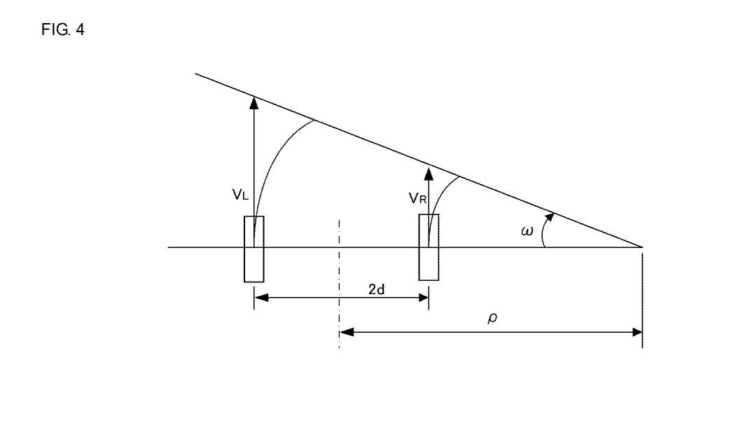

The yaw angular velocity ω is an angular velocity (rad/s) of the pushcart 1 in the yaw direction. The yaw angular velocity ω is calculated from the results of the detection performed by the rotary encoder 27A and the rotary encoder 27B, for example. The yaw angular velocity ω is 0 if the angular velocities of the first main wheel 11A and the second main wheel 11B detected and calculated by the rotary encoder 27A and the rotary encoder 27B are the same. The control unit 21 can find the yaw angular velocity ω from a difference between the angular velocities calculated from the rotation angles of the first main wheel 11A and the second main wheel 11B. As illustrated in FIG. 4, when a distance between the first main wheel 11A and the second main wheel 11B is represented by 2d, a turning curvature radius is represented by p, a velocity of the first wheel is represented by VR, and a velocity of the second wheel is represented by VL, based on a relationship where VR=(ρ−d)ω and VL=(ρ+d)ω, the yaw angular velocity ω is represented as:

$$ω = \frac{{V}_{L} - {V}_{R}}{2 d} \qquad Formula 1$$

The angular velocity ω being positive indicates rotation in the clockwise direction when the main body portion 10 is viewed from above.

Meanwhile, the yaw angular velocity can also be detected by providing a yaw rate sensor (a gyrosensor). Slipping in the first main wheel 11A and the second main wheel 11B can also be detected by employing the yaw angular velocities obtained from the rotary encoder 27A and the rotary encoder 27B in combination with the yaw rate sensor. In other words, in the case where the first main wheel 11A and the second main wheel 11B are slipping for some reason, a difference will appear in the values of the yaw angular velocity ω obtained from the rotary encoders and the yaw rate sensor, and thus it can be determined that the first main wheel 11A and the second main wheel 11B are slipping in the case where, for example, the value of the difference between the yaw angular velocities ω obtained from the rotary encoders and the yaw rate sensor is greater than a predetermined threshold. Safety measures such as stopping travel or the like can be taken in the case where it is determined that the first main wheel 11A and the second main wheel 11B are slipping.

As illustrated in FIG. 3C, the control unit 21 determines whether or not the yaw angular velocity ω falls within a first predetermined value range. In other words, the control unit 21 determines whether or not the angular velocity ω is within a range from −α to α (s11). In the case where the angular velocity ω is determined to be within the range from −α to α, the control unit 21 controls the first main wheel 11A and the second main wheel 11B so that the angular velocity ω becomes 0, and corrects the angular velocity to 0 (s12). In other words, the first main wheel 11A and the second main wheel 11B are controlled in the case where the angular velocity ω is within a range from −α to α, as indicated by the hatched areas in FIG. 3B.

Although the angular velocity ω may be determined from an instantaneous value, it should be noted that here, the process of s12 is carried out in the case where the angular velocity ω is within the range from −α to α continuously for a predetermined amount of time. Furthermore, although an example in which the yaw angular velocity is corrected to 0 is described here, it is sufficient for the correction to ensure that the yaw angular velocity falls within the first predetermined value range (the range from −α to α). For example, when the first predetermined value range (the range from −α to α) is −5 to +5 (rad/s), the first target value and the second target value may be set to +1 (rad/s) and −1 (rad/s), respectively, and the yaw angular velocity may be corrected so as to fall within a range that is narrower than the first predetermined value range.

In this manner, the angular velocity ω falls within the range from the first target value to the second target value (−α to α). In the case where the angular velocity ω falls within a given range (a first predetermined value) continuously for a predetermined amount of time, the control unit 21 determines that the user is advancing straight, and holds the change of angle in the yaw direction close to 0. Through this, small sways can be prevented, and falls can be prevented as well.

On the other hand, in the determination process of s11, the control unit 21 cancels the correction of the angular velocity (s13) in the case where it has been determined that the angular velocity ω is not within the range from −α to α. At this time, the correction may be canceled gradually rather than being canceled immediately. In other words, in the case where the angular velocity ω is outside the range of the first predetermined value, it is determined that the user is changing direction intentionally, and control for suppressing a change of angle in the yaw direction is not carried out.

Rather than the yaw angular velocity, the yaw angle may be detected and a change in that yaw angle may be used as the change of angle in the yaw direction. The yaw angle can also be detected by providing a magnetic sensor and finding a difference in the angle of the current front direction of the pushcart relative to a reference direction (for example, the front direction of the pushcart 1 when in a stopped state). In addition, the yaw angle can also be detected using the detection results from the rotary encoder 27A and the rotary encoder 27B. Slipping in the first main wheel 11A and the second main wheel 11B can also be detected by employing the yaw angles obtained from the rotary encoder 27A and the rotary encoder 27B in combination with the magnetic sensor. In other words, in the case where the first main wheel 11A and the second main wheel 11B are slipping for some reason, a difference will appear in the values of the yaw angular velocity ω obtained from the rotary encoders and the magnetic sensor, and thus it can be determined that the first main wheel 11A and the second main wheel 11B are slipping in the case where, for example, the value of the difference between the yaw angular velocities ω obtained from the rotary encoders and the magnetic sensor is greater than a predetermined threshold. Safety measures such as stopping travel or the like can be taken in the case where it is determined that the first main wheel 11A and the second main wheel 11B are slipping.

Note that the first predetermined value a may be accepted as an input from the user through the user I/F 28. In this case the first predetermined value a is inputted using a knob (a dial-based switch), a pushbutton, or the like. Alternatively, a numerical value may be inputted directly using a remote controller connected with a wire or wirelessly. The value may be inputted by voice as well.

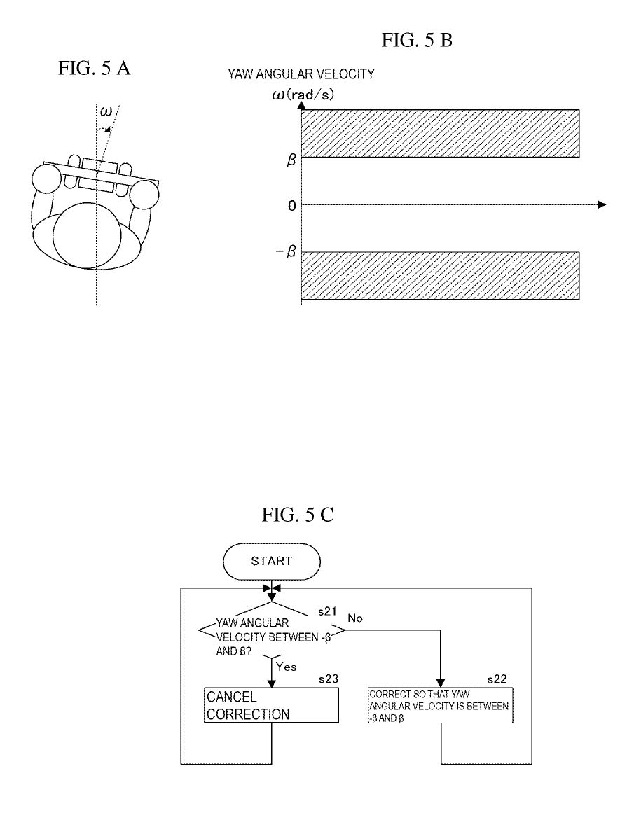

Next, FIG. 5 includes diagrams illustrating an example of suppressing the yaw angular velocity ω to within a second predetermined value range, as a second example. FIG. 5A is a diagram illustrating the yaw angular velocity ω, FIG. 5B is a diagram illustrating a relationship between the yaw angular velocity ω and control being on or off, and FIG. 5C is a flowchart illustrating operations performed by the control unit 21.

As illustrated in FIG. 5C, the control unit 21 determines whether or not the yaw angular velocity ω falls within the second predetermined value range. In other words, the control unit 21 determines whether or not the yaw angular velocity ω is within a range from −β to β (s21). In the case where it is determined that the yaw angular velocity ω is not within the range from −β to β, the control unit 21 controls the first main wheel 11A and the second main wheel 11B and corrects the yaw angular velocity ω to within the range from −β to β (s22). In other words, the first main wheel 11A and the second main wheel 11B are controlled in the case where the yaw angular velocity ω is no greater than −β or no less than β, as indicated by the hatched areas in FIG. 5B.

Although the yaw angular velocity ω may be determined from an instantaneous value here as well, it should be noted that the process of s22 is carried out in the case where the yaw angular velocity ω is outside the range from −β to β continuously for a predetermined amount of time.

The yaw angular velocity ω falls within the range from the first target value to the second target value (in this case, the first target value and β match, and the second target value and −β match) in this example as well. In the case where the yaw angular velocity ω is outside a given range (the second predetermined value range) continuously for a predetermined amount of time, the control unit 21 determines that the user is swaying greatly, and holds the change of angle in the yaw direction within the second predetermined value range so as to prevent a fall caused by the user swaying greatly.

On the other hand, in the determination process of s21, the control unit 21 cancels the correction of the yaw angular velocity (s23) in the case where it has been determined that the yaw angular velocity ω is within the range from −β to β. At this time, the correction may be canceled gradually rather than being canceled immediately.

Rather than the yaw angular velocity ω, the yaw angle may be detected and a change in that yaw angle may be used as the change of angle in the yaw direction in this example as well. Note that the second predetermined value range (β and −β) may also be accepted as an input from the user.

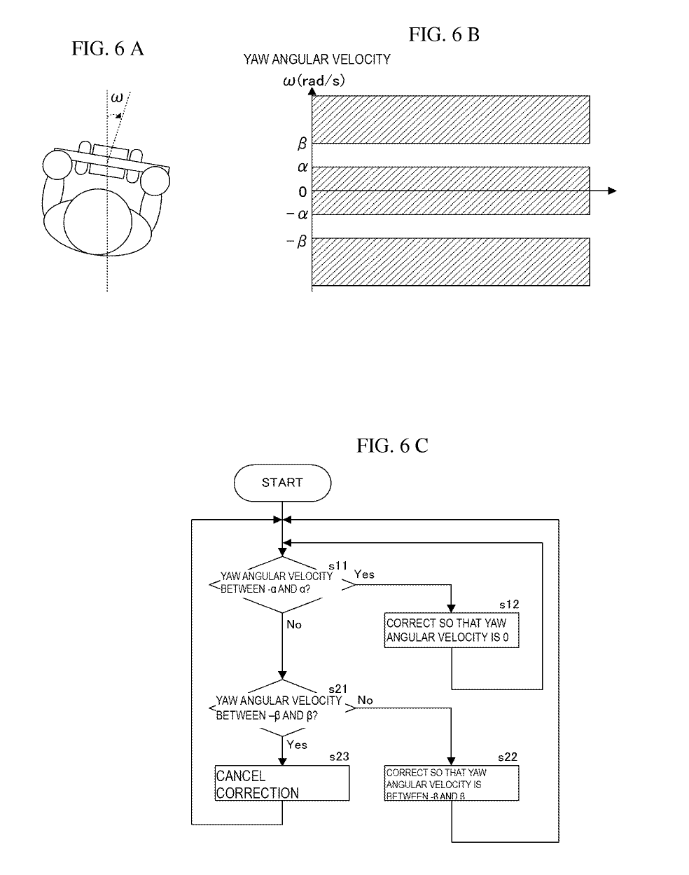

Next, FIG. 6 includes diagrams illustrating a combination of the first example and the second example. FIG. 6A is a diagram illustrating the yaw angular velocity ω, FIG. 6B is a diagram illustrating a relationship between the yaw angular velocity ω and control being on or off, and FIG. 6C is a flowchart illustrating operations performed by the control unit 21.

In this example, the control unit 21 first determines whether or not the yaw angular velocity ω is within the range from −α to α as indicated in FIG. 6C (s11), and in the case where the yaw angular velocity ω is determined to be within the range from −α to α, the control unit 21 controls the first main wheel 11A and the second main wheel 11B so that the yaw angular velocity ω becomes 0, and corrects the yaw angular velocity to 0 (s12). On the other hand, in the case where the yaw angular velocity ω is determined to not be within the range from −α to α, the control unit 21 further determines whether or not the yaw angular velocity ω is within the range from −β to β (s21). In the case where it is determined that the yaw angular velocity ω is not within the range from −β to β, the control unit 21 controls the first main wheel 11A and the second main wheel 11B and corrects the yaw angular velocity ω to within the range from −β to β (s22). In the determination process of s21, the correction of the yaw angular velocity is canceled (s23) in the case where it has been determined that the yaw angular velocity ω is within the range from −β to β.

In other words, the first main wheel 11A and the second main wheel 11B are controlled in the case where the yaw angular velocity ω is within the range from −α to α and the yaw angular velocity ω is no greater than −β or no less than β, as indicated by the hatched areas in FIG. 6B. The yaw angular velocity is canceled in the case where the yaw angular velocity ω is within the range from α to β and within the range from −β to −α.

Through this, the user can be permitted to make intentional direction changes within a given angular range while also preventing both small sways and great sways.

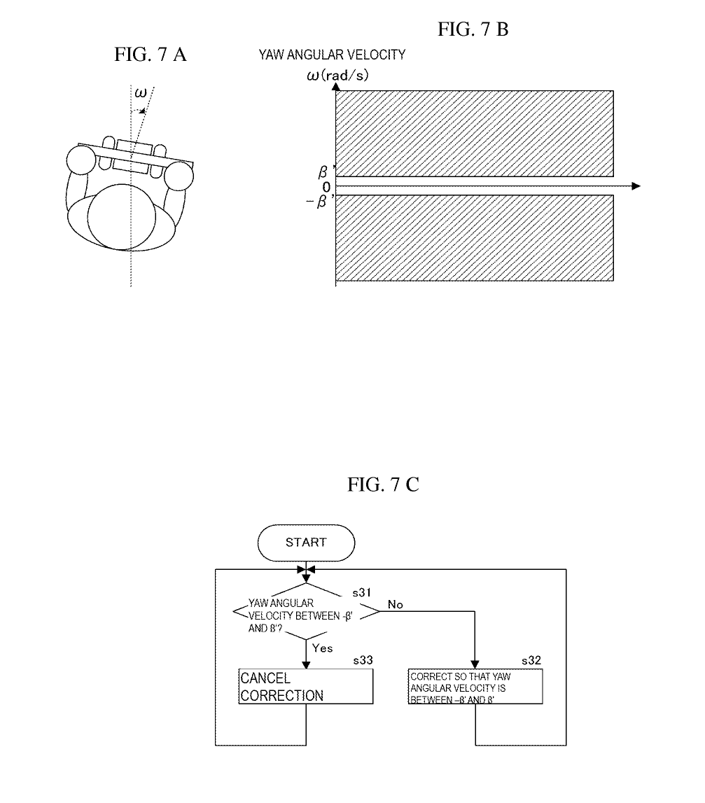

Next, FIG. 7 includes diagrams illustrating a variation on the second example. FIG. 7A is a diagram illustrating the yaw angular velocity ω, FIG. 7B is a diagram illustrating a relationship between the yaw angular velocity ω and control being on or off, and FIG. 7C is a flowchart illustrating operations performed by the control unit 21.

In this example, the same control as that in the second example illustrated in FIG. 5 is carried out, but the second predetermined value range differs greatly. In other words, the second predetermined value range in this example (−β to β′) is narrower than the range from −β to β, and is even narrower than the range from −α to α that serves as the first predetermined value range. A switch from β to β′ is carried out by accepting an input from the user through the user I/F 28.

In this example, the control unit 21 determines whether or not the yaw angular velocity co is within a range from −β′ to β′, as indicated in FIG. 7C (s31). In the case where it is determined that the yaw angular velocity ω is not within the range from −β′ to β′, the control unit 21 controls the first main wheel 11A and the second main wheel 11B and corrects the yaw angular velocity ω to within the range from −β′ to β′ (s32). In the determination process of s31, the correction of the yaw angular velocity is canceled (s33) in the case where it has been determined that the yaw angular velocity ω is within the range from −β′ to β′.

In other words, in this example, the first main wheel 11A and the second main wheel 11B are controlled in the case where the yaw angular velocity ω is no greater than −β′ or no less than β′, as indicated by the hatched areas in FIG. 7B. In this case, the yaw angular velocity ω is fixed near almost 0, and thus the pushcart 1 can be used while fixed so as to advance straight.

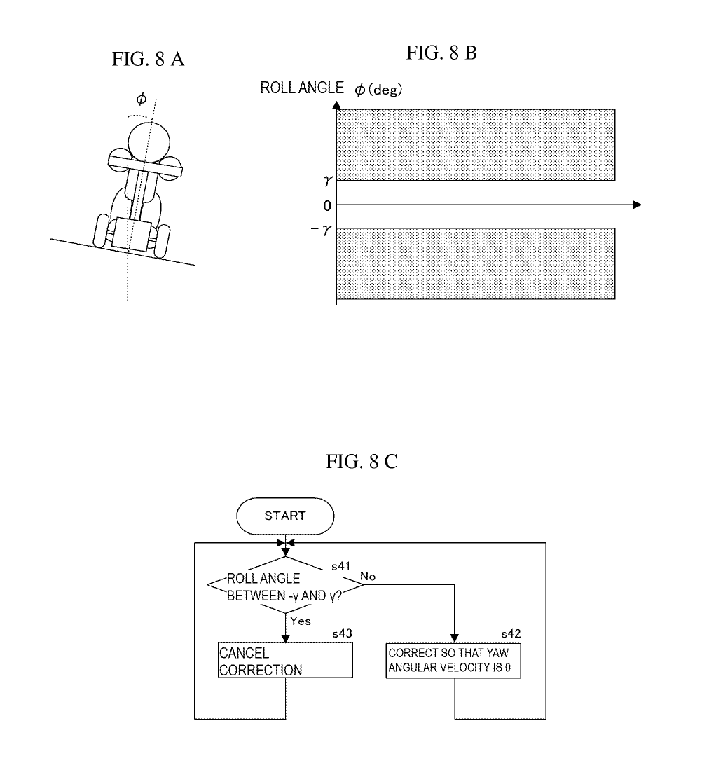

Next, FIG. 8 includes diagrams illustrating an example (a third example) of correcting the yaw angular velocity in accordance with a roll angle. FIG. 8A is a diagram illustrating a roll angle φ, FIG. 8B is a diagram illustrating a relationship between the roll angle φ and control being on or off, and FIG. 8C is a flowchart illustrating operations performed by the control unit 21.

The roll angle φ is an angle of slope relative to the vertical direction, taking the direction in which the pushcart 1 advances (the Y direction in FIG. 1) as its axis. The roll angle φ is detected using an angle of slope sensor or an accelerometer, for example. Alternatively, the roll angle φ can be calculated by detecting an axle load using a pressure sensor, and by detection using a gyrosensor.

As illustrated in FIG. 8C, the control unit 21 determines whether or not the roll angle φ falls within a third predetermined value range. In other words, the control unit 21 determines whether or not the roll angle φ is within a range from −γ to γ (s41). In the case where it is determined that the roll angle φ is not within the range from −γ to γ, the control unit 21 controls the first main wheel 11A and the second main wheel 11B and corrects the yaw angular velocity co to 0 (s42). On the other hand, in the determination process of s41, the control unit 21 cancels the correction of the yaw angular velocity (s43) in the case where it has been determined that the roll angle φ is within the range from −γ to γ. At this time, the correction may be canceled gradually rather than being canceled immediately.

Although the roll angle φ may be determined from an instantaneous value here as well, it should be noted that it is desirable for the process of s42 to be carried out in the case where it is determined that the roll angle is outside the range from −γ to γ continuously for a predetermined amount of time. Rather than the roll angle, a roll angular velocity may be detected and a change in that roll angular velocity may be used as the change of angle in the roll direction. Note that the third predetermined value may also be accepted as an input from the user. The roll angular velocity can be calculated using an angle of slope sensor, an accelerometer, or the like, and can be detected using a gyrosensor.

The yaw angular velocity ω falls close to 0 in this example as well. Through this, in the case where, for example, there is a slope in a left-right direction relative to the direction of advancement, the pushcart can be prevented from moving unintentionally in the downward direction of the slope.

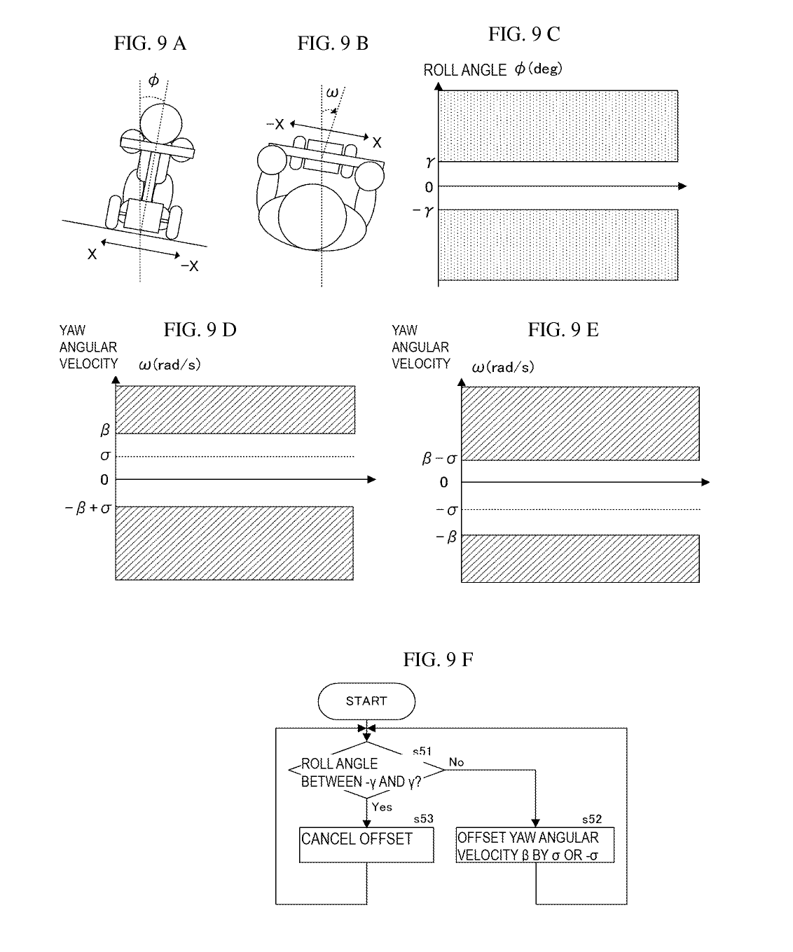

FIG. 9 includes diagrams illustrating an example (a variation on the third example) of offsetting a reference yaw angular velocity in accordance with a roll angle. FIG. 9A is a diagram illustrating the roll angle φ, FIG. 9B is a diagram illustrating the yaw angular velocity co, FIG. 9C is a diagram illustrating a relationship between the roll angle φ and the offset being on or off, FIGS. 9D and 9E are diagrams illustrating a relationship between the yaw angular velocity co and control being on or off, and FIG. 9F is a flowchart illustrating operations performed by the control unit 21.

This variation is a combination with the second example illustrated in FIG. 5, where the second predetermined value range (−β to β) is offset by a predetermined value σ).

In this example, the control unit 21 first determines whether or not the roll angle φ is within a range from −γ to γ (where γ>0), as indicated in FIG. 9F (s51). In the case where it is determined that the roll angle φ is not within the range from −γ to γ, the control unit 21 offsets the second predetermined value range (−β to β) (s52). However, in this example, in the case where the roll angle φ has become greater than or equal to γ, it is determined that the ground is slanted to the left relative to the direction of advancement, and yaw rotation to the left (counterclockwise) is restricted, as indicated in FIG. 9A and FIG. 9B. In other words, as indicated in FIG. 9D, in the case where the yaw angular velocity ω is no greater than −β+σ or is no less than β, the first main wheel 11A and the second main wheel 11B are controlled so that the yaw angular velocity ω falls within the range from −β+σ to β. In the case where the roll angle φ has become no greater than −γ, it is determined that the ground is slanted to the right relative to the direction of advancement, and yaw rotation to the right (clockwise) is restricted. In other words, as indicated in FIG. 9E, in the case where the yaw angular velocity ω is no greater than −β or is no less than β−σ, the first main wheel 11A and the second main wheel 11B are controlled so that the yaw angular velocity ω falls within the range from −β to β−σ. Note that the offset may be applied on both sides as opposed to only on one side. In other words, in the case where the roll angle φ has become no less than γ, the yaw angular velocity ω is caused to fall within a range from −β+σ to β+σ, or in the case where the roll angle φ has become no greater than −γ, the yaw angular velocity ω is caused to fall within a range from −β−σ to β−σ. Note that σ may be changed in accordance with a change of angle in the roll direction. For example, σ is increased when the angle in the roll direction is great (the slope is steep) and σ is reduced when the angle in the roll direction is small (the slope is gentle). The stability can be further improved as a result.

On the other hand, in the determination process of s51, the control unit 21 cancels the offset (s53) in the case where it has been determined that the roll angle φ is within the range from −γ to γ. When the offset is canceled, the first main wheel 11A and the second main wheel 11B are controlled in the case where the yaw angular velocity ω is no greater than −β or no less than β, as indicated in FIG. 5B.

In this variation as well, in the case where there is a slope in the left-right direction relative to the direction of advancement, the user can be permitted to change directions intentionally while preventing the pushcart from moving unintentionally in the downward direction of the slope.

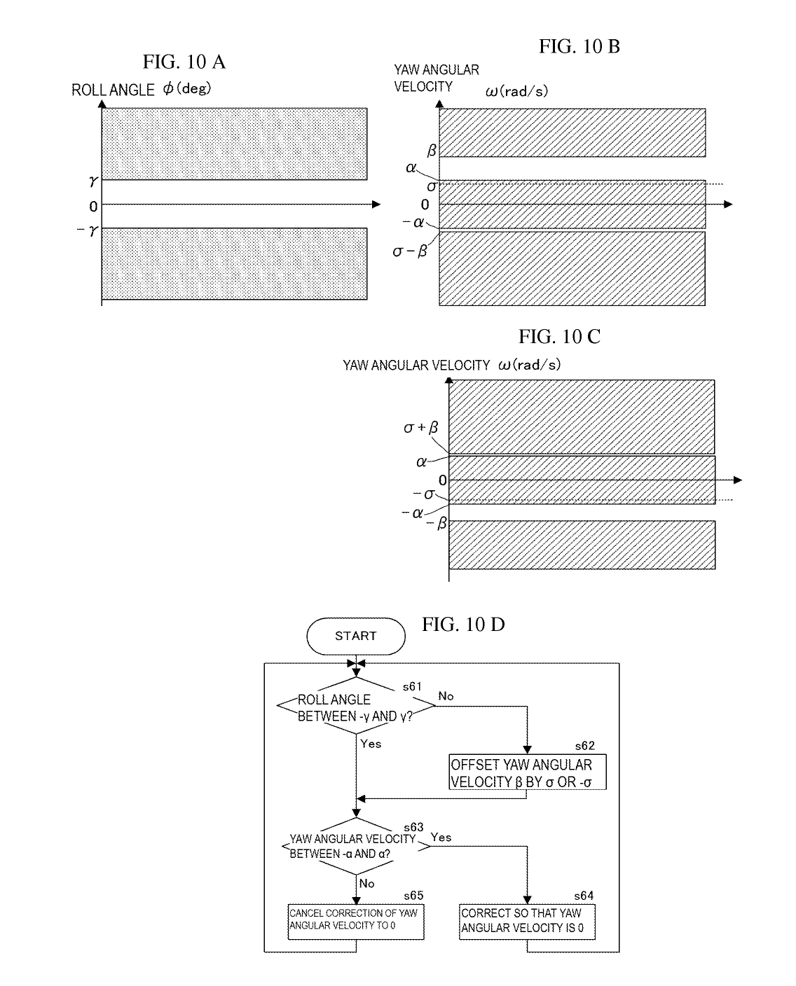

Next, FIG. 10 includes diagrams illustrating a combination of the first example and a variation on the third example. FIG. 10A is a diagram illustrating a relationship between the roll angle φ and an offset being on or off, FIGS. 10B and 10C are diagrams illustrating a relationship between the yaw angular velocity ω and control being on or off, and FIG. 10D is a flowchart illustrating operations performed by the control unit 21.

In this example, as illustrated in FIG. 10D, the control unit 21 first determines whether or not the roll angle φ is within the range from −γ to γ (s61), and in the case where it is determined that the roll angle φ is not within the range from −γ to γ, the control unit 21 offsets the aforementioned second predetermined value range (−β to β) (s62).

In this example as well, in the case where the roll angle φ has become no less than γ, as indicated in FIG. 10(B), in the case where the yaw angular velocity ω is no greater than −β+σ or is no less than β, the first main wheel 11A and the second main wheel 11B are controlled so that the yaw angular velocity ω falls within the range from −β+σ to β. In the case where the roll angle φ has become no greater than −γ, as indicated in FIG. 10(C), in the case where the yaw angular velocity ω is no greater than −β or is no less than β−σ, the first main wheel 11A and the second main wheel 11B are controlled so that the yaw angular velocity ω falls within the range from −β to β−σ. Note that the offset may be applied on both sides as opposed to only on one side in this example as well. Note also that a may be changed in accordance with a change of angle in the roll direction in this example as well.

On the other hand, the control unit 21 determines whether or not the roll angle φ is within the range from −α to α (s63), and in the case where the roll angle φ is determined to be within the range from −α to α, the control unit 21 controls the first main wheel 11A and the second main wheel 11B so that the yaw angular velocity ω becomes 0, and corrects the yaw angular velocity to 0 (s64). In the case where the yaw angular velocity ω is determined not to be within the range from −α to α, the control that corrects the yaw angular velocity to 0 is canceled (s65).

In this case as well, in the case where there is a slope in the left-right direction relative to the direction of advancement, the user can be permitted to change directions intentionally while preventing the pushcart from moving unintentionally in the downward direction of the slope, and falls caused by small sways can be prevented as well.

### REFERENCE SIGNS LIST

10 main body portion
11A first main wheel
11B second main wheel
12 support portion
13 assist wheel
15 handle
16 grip portion
20 angle of slope sensor
21 control unit
22 ROM
23 RAM
24 gyrosensor
25 first main wheel driving unit
26 second main wheel driving unit
27A, 27B rotary encoder
29 manual brake

1. A pushcart comprising:
a pair of wheels;
a main body portion that supports the pair of wheels so as to be rotatable in a pitch direction;
a driving control unit that drives and controls each wheel in the pair of wheels individually; and
a yaw detection means that detects a change of angle of the main body portion in a yaw direction,
wherein the driving control unit drives and controls each wheel in the pair of wheels individually so that the change of angle in the yaw direction falls within a range from a first target value to a second target value.

2. The pushcart according to claim 1,
wherein in the case where the change of angle in the yaw direction is within a first predetermined value range for a predetermined amount of time, the driving control unit sets the first target value and the second target value to fall within the first predetermined value range.

3. The pushcart according to claim 2, further comprising:
a first input means that accepts an input of the first predetermined value range.

4. The pushcart according to claim 1,
wherein in the case where the change of angle in the yaw direction is outside a second predetermined value range for a predetermined amount of time, the driving control unit sets the first target value and the second target value to fall within the second predetermined value range.

5. The pushcart according to claim 4, further comprising:
a second input means that accepts an input of the second predetermined value range.

6. The pushcart according to claim 1, further comprising:
a roll detection means that detects a change of angle of the main body portion in a roll direction,
wherein in the case where the change of angle in the roll direction is outside a third predetermined value range for a predetermined amount of time, the driving control unit changes the first target value and/or the second target value.

7. The pushcart according to claim 6, further comprising:
a third input means that accepts an input of the third predetermined value range.

8. The pushcart according to claim 1, further comprising:
a target value input means that accepts an input of the first target value or the second target value.

9. The pushcart according to claim 1,
wherein the yaw detection means detects the change of angle in the yaw direction by detecting a rotation angle or an angular velocity of each wheel in the pair of wheels.

10. The pushcart according to claim 9,
wherein the yaw detection means includes a yaw angular velocity sensor or a magnetic sensor.

11. The pushcart according to claim 1, wherein the yaw detection means comprises a magnetic sensor that detects an angle of a current front direction of the pushcart relative to a front direction of the pushcart when the pushcart is stopped.

12. The pushcart according to claim 1, wherein the yaw detection means comprises a rotary encoder that detects rotation angles of each of the wheels in the pair of wheels.

13. The pushcart according to claim 1, wherein the yaw detection means comprises a rotary encoder, a magnetic sensor, a yaw angular velocity sensor, a slope angle sensor, an accelerometer, or combinations thereof.

14. The pushcart according to claim 2,
wherein in the case where the change of angle in the yaw direction is outside a second predetermined value range for a predetermined amount of time, the driving control unit sets the first target value and the second target value to fall within the second predetermined value range.

15. The pushcart according to claim 3,
wherein in the case where the change of angle in the yaw direction is outside a second predetermined value range for a predetermined amount of time, the driving control unit sets the first target value and the second target value to fall within the second predetermined value range.

16. The pushcart according to claim 2, further comprising:
a roll detection means that detects a change of angle of the main body portion in a roll direction,
wherein in the case where the change of angle in the roll direction is outside a third predetermined value range for a predetermined amount of time, the driving control unit changes the first target value and/or the second target value.

17. The pushcart according to claim 3, further comprising:
a roll detection means that detects a change of angle of the main body portion in a roll direction,
wherein in the case where the change of angle in the roll direction is outside a third predetermined value range for a predetermined amount of time, the driving control unit changes the first target value and/or the second target value.

18. The pushcart according to claim 4, further comprising:
a roll detection means that detects a change of angle of the main body portion in a roll direction,
wherein in the case where the change of angle in the roll direction is outside a third predetermined value range for a predetermined amount of time, the driving control unit changes the first target value and/or the second target value.

19. The pushcart according to claim 5, further comprising:
a roll detection means that detects a change of angle of the main body portion in a roll direction,
wherein in the case where the change of angle in the roll direction is outside a third predetermined value range for a predetermined amount of time, the driving control unit changes the first target value and/or the second target value.

20. The pushcart according to claim 2, further comprising:
a target value input means that accepts an input of the first target value or the second target value.
